(19) United States
(12) Patent Application Publication
(10) Pub. No.: US 2024/0180119 A1
(43) Pub. Date: Jun. 6, 2024

(54) SYSTEM FOR A SENIOR PET LITTERBOX WITH AN INTERNAL PLATFORM

(71) Applicants: Stacey Bone, Chesterfield, MO (US); Jeffrey Harms, St. Louis, MO (US)

(72) Inventors: Stacey Bone, Chesterfield, MO (US); Jeffrey Harms, St. Louis, MO (US)

(21) Appl. No.: 18/060,786

(22) Filed: Dec. 1, 2022

(51) Int. Cl. A01K 1/01

(52) U.S. Cl. CPC A01K 1/0107

(57) ABSTRACT

A pet litterbox for animals that may experience joint pain or arthritis. The device comprises an entrance ramp that allows for ease of access to the animal. The device is configured to have an internal platform that slopes into the basin so that the animal may enter, use, and leave the litterbox without straining their joints. The device additionally comprises an overhanging edge for transportability.

### BACKGROUND

### 1. Field of the Invention

This invention relates to a litterbox for domestic animals, especially for cats. In particular, this invention relates to systems for senior and arthritic animals.

### 2. Description of Related Art

It is known in the field of human and veterinary medicine that as animals age, normal wear affects the smooth layer of cartilage covering the bones in joint systems throughout the body. This wear can develop into an arthritic condition, often referred to as osteoarthritis or degenerative joint disease. Arthritis occurs when there is inflammation in one or more joints, and can cause pain and stiffness that worsens with age.

For example, studies show that between 70-90% of cats over 12 years old display signs of osteoarthritis in at least one joint. The incidence of osteoarthritis increases with age. Because cats are prey animals they commonly mask their direct pain symptoms, and it is not uncommon for pet owners to notice a change in behavioral characteristics first. These behavioral changes can include reluctance or complete avoidance of using the litterbox. The conventional design for litterboxes typically includes a lip around the entire edge of the box, which can be difficult and painful for an animal experiencing arthritis. Additionally, the texture of conventional litter is similar to that of sand, which displaces as the animal stands on it, placing increased pressure on the joints while using the litterbox. As the animal begins to associate pain with the litterbox, they avoid using it.

So as to reduce the complexity and length of the Detailed Specification, and to fully establish the state of the art in certain areas of technology, Applicant(s) herein expressly incorporate(s) by reference all of the following materials identified in each numbered paragraph below.

U.S. Pat. No. D639,000 discloses a design for general use pet litterbox. The litterbox has four walls and a flat internal basin.

U.S. Pat. App. Pub. No. 2004129230 A1 discloses a pet litterbox with an entrance ramp.

U.S. Pat. No. 6,892,670 discloses a pet litterbox with an internal basin that tapers upward towards the back of the litterbox.

An unpatented product titled “KittyGoHere Senior Litterbox” (https://www.amazon.com/Kitty-Go-Here-Traditional-Dimensions-No/dp/B074SBED35?th=1) discloses a pet litterbox with a break in the front wall for entry. The product also has lower walls than most general use pet litterboxes to allow for the animal to enter and exit the litterbox more easily. It is specifically marketed to older animals.

Applicant(s) believe(s) that the material incorporated above is “non-essential” in accordance with 37 CFR 1.57, because it is referred to for purposes of indicating the background of the invention or illustrating the state of the art. However, if the Examiner believes that any of the above-incorporated material constitutes “essential material” within the meaning of 37 CFR 1.57(c)(1)-(3), Applicant(s) will amend the specification to expressly recite the essential material that is incorporated by reference as allowed by the applicable rules.

### SUMMARY

The present invention provides among other things a pet litterbox with an internal platform configured for animals that may experience joint pain, arthritis, or other conditions that affect their range of motion. The entrance ramp provides an ingress and egress point for the animal that does not require stepping over a wall. Additionally, the pet litterbox has an internal platform for the animal to stand on while in the litterbox so as not to strain their joints during use.

The pet litterbox comprises an entrance ramp, a threshold coupled to the entrance ramp, and a basin coupled to the threshold. The basin further comprises a back wall, at least one side wall, a front wall, an outer edge coupled to the side wall and back wall, a basin floor, and an internal platform. The internal platform further comprises an upper face that extends at a downward angle towards the back wall, and at least one side face that extends at a downward angle towards the side wall. The internal platform is coupled to the threshold. The litterbox also provides a rubberized pad attached to the entrance ramp.

Additionally, the internal platform and basin floor are configured to be interior to the basin. There is an overhanging edge that is coupled to the back wall and the side wall extending in a direction exterior to the basin.

Aspects and applications of the invention presented here are described below in the drawings and detailed description of the invention. Unless specifically noted, it is intended that the words and phrases in the specification and the claims be given their plain, ordinary, and accustomed meaning to those of ordinary skill in the applicable arts. The inventor is fully aware that he can be his own lexicographer if desired. The inventor expressly elects, as his own lexicographers, to use only the plain and ordinary meaning of terms in the specification and claims unless he clearly states otherwise and then further, expressly sets forth the “special” definition of that term and explains how it differs from the plain and ordinary meaning. Absent such clear statements of intent to apply a “special” definition, it is the inventor's intent and desire that the simple, plain and ordinary meaning to the terms be applied to the interpretation of the specification and claims.

The inventor is also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventor is fully informed of the standards and application of the special provisions of 35 U.S.C. § 112(f). Thus, the use of the words “function,” “means” or “step” in the Detailed Description or Description of the Drawings or claims is not intended to somehow indicate a desire to invoke the special provisions of 35 U.S.C. § 112(f), to define the invention. To the contrary, if the provisions of 35 U.S.C. § 112(f) are sought to be invoked to define the inventions, the claims will specifically and expressly state the exact phrases “means for” or “step for, and will also recite the word “function” (i.e., will state “means for performing the function of [insert function]”), without also reciting in such phrases any structure, material or act in support of the function. Thus, even when the claims recite a “means for performing the function of . . . ” or “step for performing the function of . . . ,” if the claims also recite any structure, material or acts in support of that means or step, or that perform the recited function, then it is the clear intention of the inventor not to invoke the provisions of 35 U.S.C. § 112(f). Moreover, even if the provisions of 35 U.S.C. § 112(f) are invoked to define the claimed inventions, it is intended that the inventions not be limited only to the specific structure, material or acts that are described in the preferred embodiments, but in addition, include any and all structures, materials or acts that perform the claimed function as described in alternative embodiments or forms of the invention, or that are well known present or later-developed, equivalent structures, material or acts for performing the claimed function.

The foregoing and other aspects, features, and advantages will be apparent to those artisans of ordinary skill in the art from the DETAILED DESCRIPTION and DRAWINGS, and from the CLAIMS.

### BRIEF DESCRIPTION OF THE SEVERAL VIEWS OF THE DRAWINGS

A more complete understanding of the present invention may be derived by referring to the detailed description when considered in connection with the following illustrative figures. In the figures, like reference numbers refer to like elements or acts throughout the figures.

FIG. 1 depicts a perspective view showing internal and external features of the litterbox of the present patented invention.

FIG. 2 depicts a front view of the entrance ramp and litterbox.

FIG. 3 depicts a rear view of the litterbox.

FIG. 4 depicts a top view of the entrance ramp, internal platform, and litterbox.

FIG. 5 depicts a bottom view of the litterbox.

FIG. 6 depicts a side view of the entrance ramp and litterbox.

FIG. 7 depicts a side cross-sectional view of the litterbox and the litter line.

FIG. 8 depicts a rear cross-sectional view of the internal platform and litterbox.

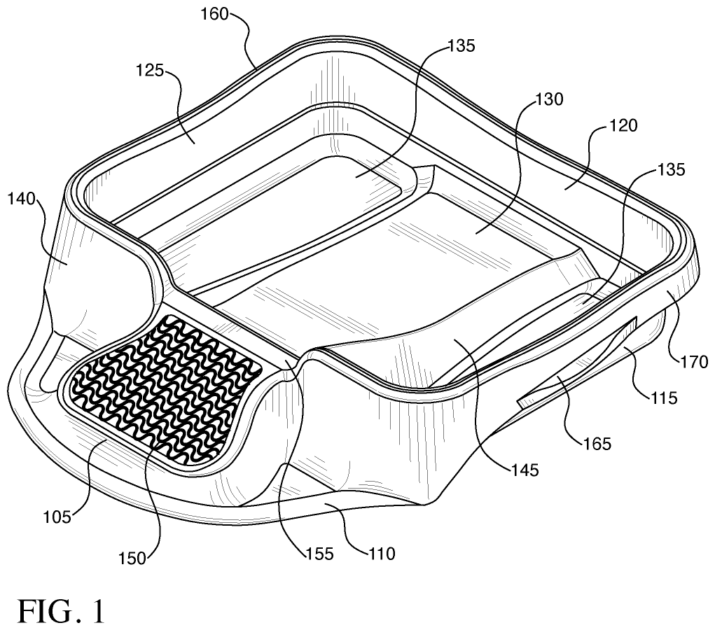

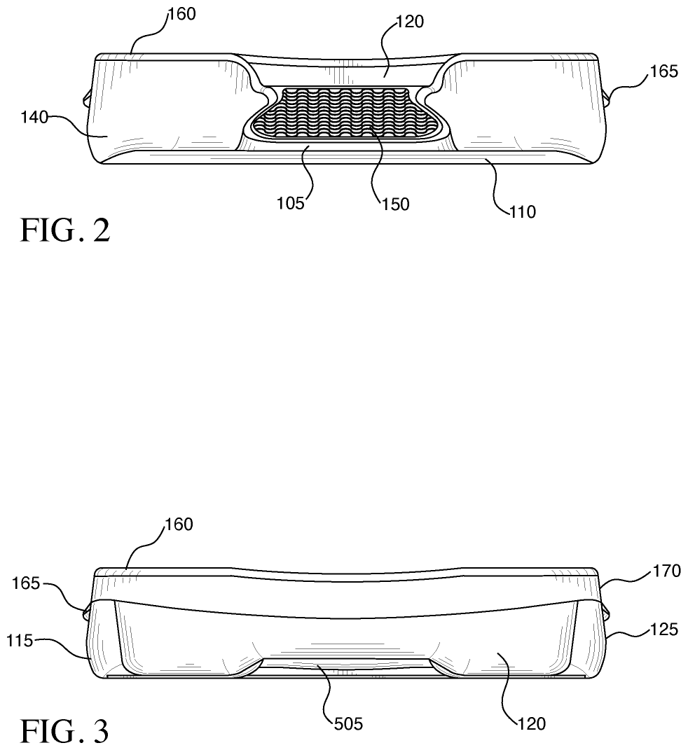

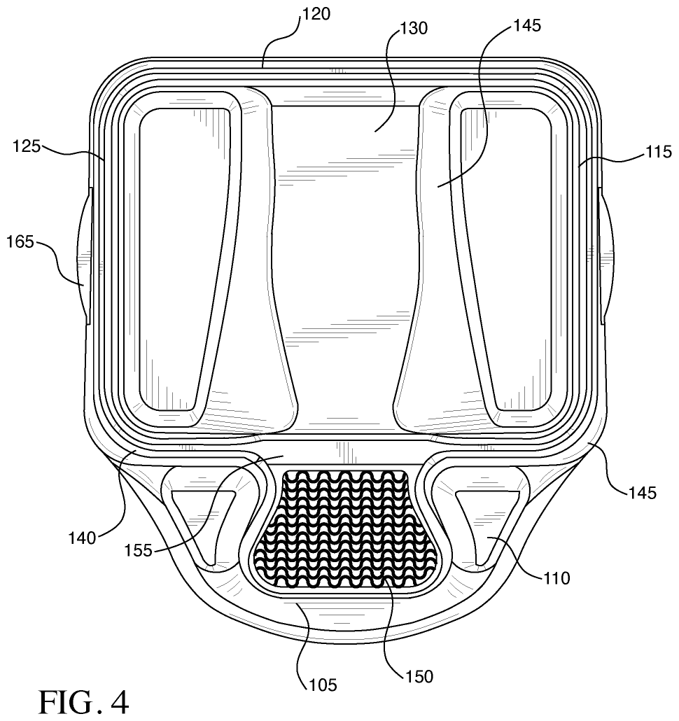

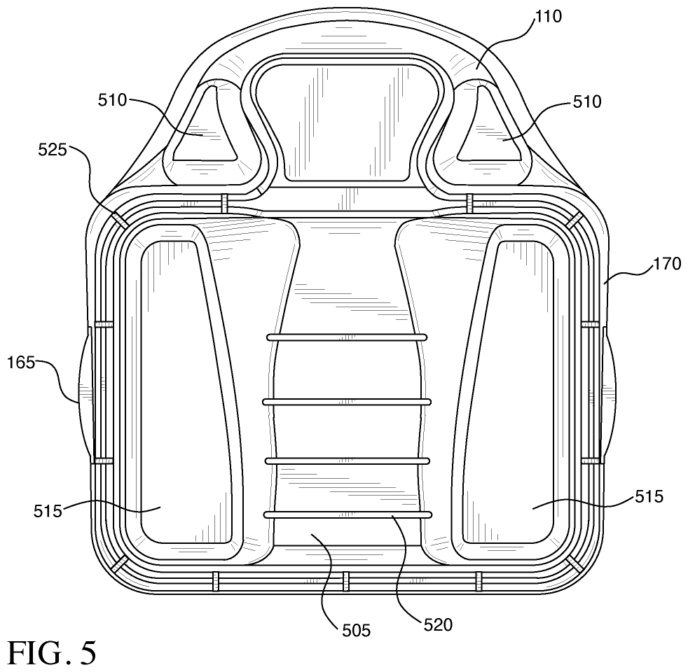

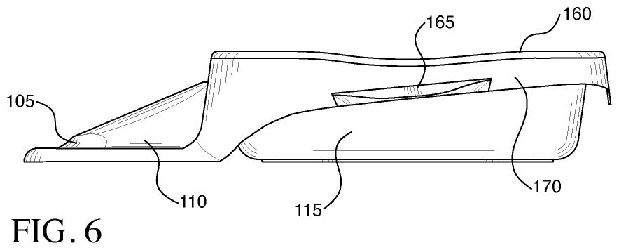

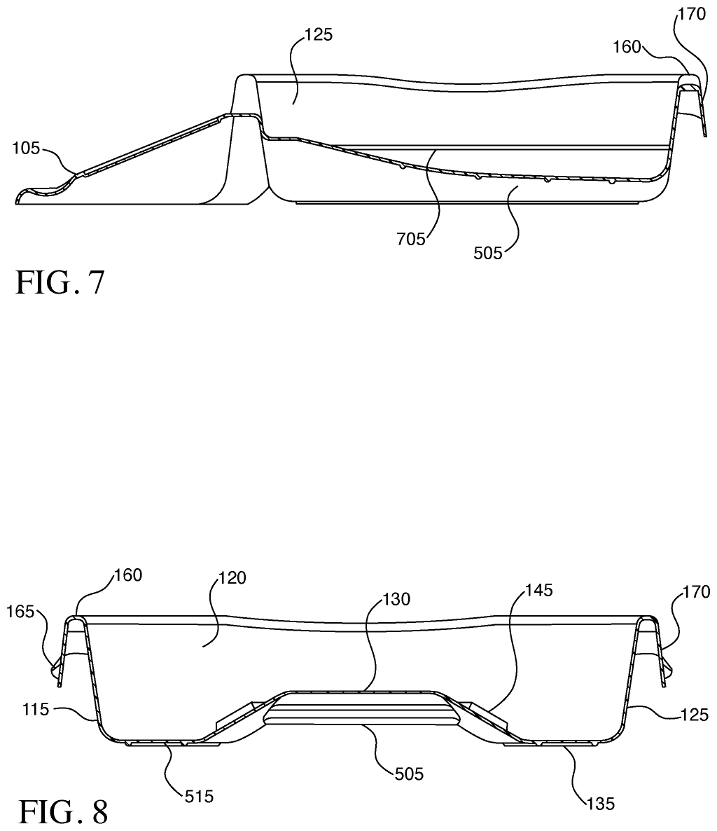

Elements and acts in the figures are illustrated for simplicity and have not necessarily been rendered according to any particular sequence or embodiment.

### DETAILED DESCRIPTION

In the following description, and for the purposes of explanation, numerous specific details are set forth in order to provide a thorough understanding of the various aspects of the invention. It will be understood, however, by those skilled in the relevant arts, that the present invention may be practiced without these specific details. In other instances, known structures and devices are shown or discussed more generally in order to avoid obscuring the invention. In many cases, a description of the operation is sufficient to enable one to implement the various forms of the invention, particularly when the operation is to be implemented in software. It should be noted that there are many different and alternative configurations, devices and technologies to which the disclosed inventions may be applied. The full scope of the inventions is not limited to the examples that are described below.

In one exemplary embodiment, the litterbox may comprise an entrance ramp 105, a front wall 140, a first side wall 115, a second side wall 125, a rear wall 120, an upper platform face 130, side platform faces 145, a floor 135, and an underside 505. The front wall 140 may be coupled to the first side wall 115 and the second side wall 125. Additionally, the first side wall 115 and second side wall 125 may be coupled to the rear wall 120. In this exemplary embodiment, the first side wall 115, second side wall 125, and rear wall 120 may be integral to one another.

This exemplary embodiment may further comprise an internal platform comprised of an upper platform face 130 and side platform faces 145. In this exemplary embodiment, the litterbox may further comprise a front edge 110. The entrance ramp 105 may extend at an upward angle from the front edge 110 to the front wall 140. Where the entrance ramp 105 meets the front wall 140, there may be a threshold 155 between the entrance ramp 105 and upper platform face 130. This embodiment may further comprise a rubberized pad 150 attachment that aids in traction. The rubberized pad 150 may be formed from silicone or a similar material. Additionally, the rubberized pad 150 may be textured so as to allow for better traction.

In this exemplary embodiment, the internal platform 130 may further comprise an upper face, a first side face, and a second side face. The upper face may extend at a downward angle from the threshold 155 towards the rear wall 120 of the basin. The upper face may extend from the threshold 155 to a point on the rear wall 120 of the basin, or a point on the floor 135 of the basin. The first side face 145 and second side face may extend at a downward angle from an edge of the upper face to the floor 135 of the basin.

In this exemplary embodiment, the underside 505 of the invention may have inner support ribs 520 and outer support ribs 525 that provide support and stability when in use. The inner support ribs 520 may be on the area corresponding to an underside 505 of the upper platform face 130. The outer support ribs 525 may be positioned between the overhanging edge 170 and the inner support ribs 520 on the underside 505. This embodiment may further comprise a pair of forward feet 510 and a pair of rear feet 515 on the underside 505. The forward feet 510 may be between the front edge 110 and area corresponding to the underside the entrance ramp 105. The rear feet 515 may be between the outer support ribs 525 and the inner support ribs 520 on the underside 505.

In this exemplary embodiment, the internal platform 130 and floor 135 are interior to the basin. This exemplary embodiment may further comprise an overhanging edge 170 that extends from the top edge 160 and runs along the first side wall 115, back wall 120, and second side wall 125. The overhanging edge 170 may extend in a direction that is exterior to the basin. This embodiment may further comprise a first tab 165 associated with the overhanging edge 170 on the first side wall 115 and second tab 165 associated with the overhanging edge 170 of the second side wall 125.

This exemplary embodiment may further comprise a litter line 705 on the interior perimeter of the first side wall 115, rear wall 120, and second side wall 125 of the basin.

In an alternative exemplary embodiment, the litterbox may comprise an entrance ramp 105, a front wall 140, a first side wall 115, a second side wall 125, a rear wall 120, an upper platform face 130, side platform faces 145, a floor 135, and an underside 505.

In this exemplary embodiment, the side platform faces 145 of the internal platform may decline steppedly into the floor 135 of the basin. The side platform faces 145 may be coupled to the floor 135 of the basin. Alternatively, the side platform faces 145 may extend toward the first side wall 125 of the basin. The side platform faces 145 may be coupled to the first side wall 125 of the basin.

In this exemplary embodiment, the upper platform face 130 may decline steppedly toward the rear wall 120 of the basin. The upper platform face 130 may be coupled to the rear wall 120 of the basin. Alternatively, the upper platform face 130 may be coupled to the floor 135 of the basin. The internal platform may be integral to the basin. The upper platform face 130 and side platform faces 145 may be a separate attachment added to the basin. Additionally, the upper platform face 130 may be a separate attachment added to the side platform faces 145. Alternatively, the upper platform face 130 may be integral to the side platform faces 145.

In this exemplary embodiment, the entrance ramp 105 may be a separate attachment added onto basin. This embodiment may also employ an entrance step system that may be a separate attachment added to the basin. Alternatively, the entrance step system may be integral to the basin.

In this exemplary embodiment, the front wall 140, first side wall 115, second side wall 125, and rear wall 120 may be separate components that are coupled together. Alternatively, this embodiment may only have a first side wall 115, second side wall 125, and rear wall 120. In yet another alternative embodiment, this litterbox may only have a front wall 140, first side wall 115, and rear wall 120.

This exemplary embodiment may be formed out of polypropylene. The upper platform face 130, side platform faces 145, and floor 135 of the basin may be textured to allow for better traction.

In another exemplary embodiment, the internal platform may have an upper platform face 130 and one side platform face 145. The upper platform face 130 may be coupled to the first side wall of the basin 115, and the side platform face 145 may decline at a slope towards the floor 135. Alternatively, the side platform face 145 may decline at a slope towards the second side wall 125.

In another exemplary embodiment, the internal platform may have an upper platform face 130 and a multitude of side platform faces 145. The side platform faces 145 may decline toward the floor 135, the first side wall 115, the second side wall 125, or the rear wall 120. The side platform faces 145 may be coupled to the floor 135, the first side wall 115, the second side wall 125, or the rear wall 120. Alternatively, the side platform faces 145 may decline towards various points on the floor 135, the first side wall 115, the second side wall 125, or the rear wall 120.

I/We claim:

1. A pet litterbox comprising:
an entrance ramp;
a threshold coupled to the entrance ramp;
a basin coupled to the threshold, further comprising:
a back wall;
at least one side wall;
a front wall;
an outer edge coupled to the side wall and back wall;
a basin floor; and
an internal platform comprising:
an upper platform face, wherein the upper face extends at a downward angle towards the back wall; and
at least one side platform face, wherein the side face extends at a downward angle towards the side wall;
wherein the internal platform is coupled to the threshold.

2. The pet litterbox of claim 1, further comprising
a rubberized pad coupled to said entrance ramp.

3. The pet litterbox of claim 2, wherein the rubberized pad is comprised of silicone.

4. The pet litterbox of claim 1, wherein the front wall of the basin comprises a depression proximal to a coupling point between the front wall of the basin and the threshold.

5. The pet litterbox of claim 1, wherein the internal platform and basin floor are configured to be interior to the basin.

6. The pet litterbox of claim 5, further comprising:
an overhanging edge coupled to the back wall and the side wall extending in a direction exterior to the basin.

7. The pet litterbox of claim 1, wherein that pet litterbox is at least partially comprised of a polypropylene.

8. A pet litterbox comprising:
an internal platform comprising:
an upper platform face, wherein the upper face extends at a downward angle towards a back wall of a basin in which the internal platform is located; and
at least one side platform face, wherein the side platform face extends toward a side wall of the basin at a downward angle towards the basin floor.

9. The pet letterbox of claim 8, wherein the upper platform face is coupled to the back wall of the basin.

10. The pet letterbox of claim 8, wherein the at least one side platform face is coupled to the basin floor.

11. A method of manufacturing a pet litterbox, comprising the steps of:
forming an entrance ramp;
forming a threshold coupled to the entrance ramp;
forming a basin, the basin further comprising:
a back wall;
at least one side wall;
a front wall;
an outer edge coupled to the side wall and back wall;
a basin floor; and
an internal platform further comprising:
an upper platform face; and
a side platform face;
wherein the internal platform is coupled to the threshold;
via a mold.

12. The method of claim 11, further comprising the step of:
coupling a rubberized pad to the entrance ramp.
